(19) United States
(12) Patent Application Publication
(10) Pub. No.: US 2026/0104366 A1
(43) Pub. Date: Apr. 16, 2026

(54) MICROWAVE ICE DETECTION DEVICE AND SYSTEM BASED ON CAPACITIVELY COUPLED SPLIT-RING RESONATOR

(71) Applicant: Beijing Institute of Technology, Beijing (CN)

(72) Inventors: Mengjie Song, Beijing (CN); Long Zhang, Beijing (CN); Han Shi, Beijing (CN); Xuan Zhang, Beijing (CN); Sirui Yu, Beijing (CN); Yuanhanmin Chen, Beijing (CN)

(73) Assignee: Beijing Institute of Technology, Beijing (CN)

(21) Appl. No.: 19/358,564

(22) Filed: Oct. 15, 2025

(30) Foreign Application Priority Data
Oct. 15, 2024 (CN) 202411433276.9

(51) Int. Cl. G01N 22/04; G01B 15/02; G01K 13/00; H01P 7/08

(52) U.S. Cl. CPC G01N 22/04; G01B 15/025; H01P 7/082; G01K 13/00

(57) ABSTRACT

A microwave ice detection device and a system based on a capacitively coupled split-ring resonator is provided. A first split ring and a second split ring which are oppositely arranged are arranged on a substrate, and a first microstrip line and a second microstrip line are arranged at the side portions of the first split ring and the second split ring. Microwave signals with variable frequencies are applied to the first split ring, the second split ring, the first microstrip line and the second microstrip line. The microwave signals are uniformly scattered and generate reflection, transmission and absorption phenomena with a mixture of water, ice and air on the detection surface, and the reflected, transmitted and absorbed microwave signals are analyzed to determine the icing information.

### CROSS-REFERENCE TO RELATED APPLICATION

This application claims the priority of Chinese Patent Application No. 202411433276.9, filed with the Chinese Patent National Intellectual Property Administration on Oct. 15, 2024, which is incorporated herein by reference in its entirety as part of the present application.

### TECHNICAL FIELD

The disclosure relates to the technical field of ice detection, in particular to a microwave ice detection device and system based on a capacitively coupled split-ring resonator.

### BACKGROUND

Icing is a phenomenon that water droplets/water films are solidified and accumulated on a low-temperature surface in a cold climate, which is affected by the surface properties of the icing position and the external environmental conditions such as temperature and humidity. Ice accumulation is prevalent across fields, such as aerospace, energy and transportation, power and communications, maritime navigation, and polar expeditions, posing significant hazards and potentially causing severe losses of life and property. In the field of aerospace, when water droplets come into contact with the exposed surface of the aircraft, it is very easy to cause atmospheric icing, which is particularly dangerous for the aircraft, because the presence of ice impairs the aerodynamic characteristics of the flight surface, resulting in adverse effects such as increased drag, reduced lift, accelerated stall speed, increased fuel consumption, and sometimes even catastrophic flight accidents. In the field of energy transportation, the accumulation of ice reduces the efficiency of wind turbines by variable their aerodynamic shape, resulting in increased energy consumption. In the field of power and communications, when ice accumulates on transmission or communication lines, which may cause line outages, thus disrupting the normal operation of the energy sector. Ice on the base station radome may distort the phase of the transmission signal, increase its transmission loss and degrade system performance. In the field of navigation and polar scientific research, sea fog and wave may cause the deck of a ship to freeze rapidly at low temperatures, and the rapid increase of ice above the deck may cause the center of gravity of the ship to rise, which may lead to instability and eventually capsize. The development of ice detection technology helps to avoid or reduce the harm caused by ice.

At present, most of the ice thickness detection technologies are based on the measurement of the optical, electromagnetic, mechanical and thermal characteristics of ice to determine whether it is frozen or not and the thickness information of the ice. In some studies the icing state of the detection surface is determined by image recognition of the detection surface, but there is a significant deviation during the image recognition because of the minimal color difference between water, ice and air. Based on the photoelectric voltage effect, some studies have fitted the mathematical relationship between the ice thickness and the photoelectric voltage to determine the ice thickness information, but this method requires the sensor to be embedded in the water or ice on the detection surface, which limits its application in some aspects. Some research is based on electromagnetics to detect ice thickness by measuring the resistance of ice and air, but this method is limited to the detection of fixed positions. Some studies are based on mechanics to detect ice thickness, and the ice thickness is determined by the mass of ice or water on the device, but this method is highly susceptible to environmental interference, leading to a substantial reduction in accuracy.

Therefore, currently, when the icing detection is carried out by using optical, electromagnetic, mechanical and thermal characteristics of ice, the detection result is greatly affected by the environment during measurement, so the accuracy of the detection result in the icing detection is low, and the icing detection is difficult to be widely applied.

### SUMMARY

The embodiment of the disclosure provides a microwave ice detection device and a system based on a capacitively coupled split-ring resonator, which can solve the problem in the prior art that the accuracy of the detection result in the ice detection is low due to the fact that the detection result is greatly influenced by the environment during measurement when the ice detection is carried out through optical, electromagnetic, mechanical and thermal characteristics used currently.

The embodiment of the disclosure provides a microwave ice detection device based on a capacitively coupled split-ring resonator, which comprises a microwave signal controller, wherein the microwave signal controller is in communication connection with a microwave resonant sensor;
the microwave resonant sensor comprises a substrate arranged on the top surface of a metal shielding plate, and copper foil is etched on a top surface of the substrate;
the copper foil comprises a first split ring and a second split ring which are arranged opposite to each other, wherein openings of the first split ring and the second split ring face with each other; a first microstrip line is arranged on the side of the first split ring and extends to the edge of the substrate; a second microstrip line is arranged on the side of the second split ring and extends to the edge of the substrate;
in response to that ice formation occurs on a surface of the microwave resonant sensor, the microwave signal controller transmits a microwave signal with a variable frequency to the copper foil, and the first split ring and the second split ring transmit, to a mixture on the surface of the microwave resonant sensor, a microwave signal, which is reflected, transmitted and absorbed by the mixture to form a measurement signal; and
the microwave signal controller is configured to acquire a resonance amplitude value and a resonance frequency of the measurement signal, after the measurement signal is transmitted to the microwave signal controller, and acquire ice thickness information according to the resonance amplitude value and the resonance frequency.

In some embodiments, the end of the first microstrip line is provided with a first signal interface, and the end of the second microstrip line is provided with a second signal interface; and
the first signal interface is connected with an input port of the microwave signal controller, and the second signal interface is connected with an output port of the microwave signal controller.

In some embodiments, the microwave resonant sensor, the metal shielding plate and the microwave signal controller are assembled and arranged in an ice thickness detector housing in sequence, and the ice thickness detector housing is installed on a surface of icing equipment.

In some embodiments, a plurality of power line holes are formed in a side wall of the ice thickness detector housing; and
a power line is arranged in one of the plurality of power line holes, and is connected with a transformer of the microwave signal controller;
a signal transmission line is arranged in another one of the plurality of power line holes, and is connected with a processor of the microwave signal controller.

In some embodiments, for the microwave signal controller, components are embedded on a printed circuit board, and the printed circuit board formed is installed in a protective shell or independently arranged outside the microwave ice detection device.

The embodiment of the disclosure also provides a microwave ice detection system based on the capacitively coupled split-ring resonator, which comprises the microwave ice detection device based on the capacitively coupled split-ring resonator, and further comprises:
a temperature sensor, embedded on the microwave signal controller, having one end connected to a transformer of the microwave signal controller and an other end connected to a processor of the microwave signal controller, and configured to measure an external ambient temperature;
a wave source, embedded in the microwave signal controller, connected to the transformer and the processor of the microwave signal controller, and configured to emit a microwave signal with constant or varying power;
a transmission signal receiver, embedded in the microwave signal controller, having one end connected to the processor of the microwave signal controller and an other end connected to an input port of the microwave signal controller, and configured to introduce the measurement signal from the microwave resonant sensor; and
a reflection signal receiver, embedded in the microwave signal controller, having one end connected to the processor of the microwave signal controller and an other end connected to the output port of the microwave signal controller, and configured to receive the microwave signal emitted by the wave source and input the microwave signal into the microwave resonant sensor via the output port.

In some embodiments, the transformer is configured to convert 220V alternating current into 12V direct current, the 12V direct current drive the wave source to emit the microwave signal with constant or variable power, and the microwave signal is transmitted to the output port via the reflection signal receiver and transmitted to the microwave resonant sensor via the second signal interface to detect the ice thickness information; and
a detection signal is transmitted to the input port via the first signal interface, transmitted to the processor via the transmission signal receiver, to be comprehensively analyzed with the reflection signal in the reflection signal receiver and the wave source signal, thereby obtaining a microwave scattering parameter, and the ice thickness information is obtained through the microwave scattering parameter.

The embodiment of the disclosure provides a microwave ice detection device and system based on a capacitively coupled split-ring resonator. Compared with the prior art, the microwave ice detection device and system have the following beneficial effects:

According to the disclosure, the first split ring and the second split ring are oppositely arranged on the substrate, and the first microstrip line and the second microstrip line are arranged at the side portions of the first split ring and the second split ring, when in use, the microwave signals with variable frequencies are applied to the first split ring, the second split ring, the first microstrip line and the second microstrip line. The microwave signal is uniformly scattered, and undergoes reflection, transmission and absorption phenomena with the mixture of water, ice and air on the detection surface; the reflected, transmitted and absorbed microwave signal is analyzed to determine the icing information. The method is not influenced by the external environment, the accuracy of the detection result is greatly improved, and the ice layer information is determined by measuring the reflected microwave information as a whole. Compared with optical, electromagnetic, mechanical and thermal measurement methods, it has high measurement stability and may be widely used.

### BRIEF DESCRIPTION OF THE DRAWINGS

FIG. 1 is a structural schematic diagram of an overall three-dimensional model of a microwave ice detection device based on a capacitively coupled split-ring resonator according to an embodiment of the present disclosure;

FIGS. 2A and 2B are a schematic diagram of control and sensing portions of a microwave ice detection device and system based on a capacitively coupled split-ring resonator according to an embodiment of the present disclosure; wherein FIG. 2A is a schematic diagram of a microwave signal controller, and FIG. 2B is a structural schematic diagram of a microwave resonant sensor;

FIG. 3 is a schematic diagram of an equivalent circuit of a microwave resonant sensor of a microwave ice detection device and system based on a capacitively coupled split-ring resonator according to an embodiment of the present disclosure;

FIG. 4 is a schematic diagram of a change of a parameter S₂₁ of a capacitively coupled split-ring resonator sensor of a capacitively coupled split-ring resonator based microwave ice detection device and system under no-load condition according to an embodiment of the present disclosure;

FIG. 5 is a schematic diagram of a change of relative permittivity of a microwave ice detection device and system based on a capacitively coupled split-ring resonator with the ice thickness according to an embodiment of the present disclosure;

FIG. 6 is a schematic diagram of a change of the resonant frequency of a microwave ice detection device and system based on a capacitively coupled split-ring resonator with respect to ice thickness according to an embodiment of the present disclosure;

FIG. 7 is a schematic diagram of a change of the resonance amplitude of a microwave ice detection device and system based on a capacitively coupled split-ring resonator with respect to ice thickness according to an embodiment of the present disclosure;

FIG. 8 is a schematic plan view of a detection sensor of a microwave ice detection device based on a capacitively coupled split-ring resonator according to an embodiment of the present disclosure;

FIG. 9 is a graph of a change of a parameter S₂₁ of a microwave ice detection device and system based on a capacitively coupled split-ring resonator with respect to a microwave frequency of 1-6 GHz according to an embodiment of the present disclosure;

FIG. 10 is a graph of a change of a first resonance peak of a microwave ice detection device and system based on a capacitively coupled split-ring resonator with respect to a microwave frequency of 3.4˜4.0 GHz according to an embodiment of the present disclosure;

FIG. 11 is a graph of a change of the resonant frequency of a microwave ice detection device and system based on a capacitively coupled split-ring resonator with respect to the ice thickness according to an embodiment of the present disclosure; and

FIG. 12 is a graph of a change of the resonance amplitude of a microwave ice detection device and system based on the capacitively coupled split-ring resonator with respect to the ice thickness according to an embodiment of the present disclosure.

1, microwave resonant sensor, 101, substrate, 1021, first signal interface, 1022, second signal interface, 1031, first microstrip line, 1032, second microstrip line, 1041, first split ring, 1042, second split ring, 2, metal shielding plate, 3, microwave signal controller, 4, temperature sensor, 5, ice thickness detector housing, 6, ice thickness detection area, 7, power line, 8, signal transmission line, 9, power line hole, 301, transformer, 302, processor, 303, wave source, 304, reflection signal receiver, 305, output port, 306, output signal, 307, input signal, 308, input port, 309, transmission signal receiver.

### DETAILED DESCRIPTION OF THE EMBODIMENTS

To make the above objects, features and advantages of the present disclosure more apparent, a detailed description of the preferred embodiments of the present disclosure will be made with reference to the accompanying drawings. In the following description, numerous specific details are set forth in order to provide a thorough understanding of the disclosure. This disclosure may be implemented in many other ways than those described herein, and those skilled in the art can make similar modifications without departing from the spirit of the disclosure, and thus the disclosure is not limited to the specific embodiments disclosed below.

In the description of the present disclosure, it is to be understood that, the terms “center”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial”, “radial”, “circumferential”, etc., indicate orientation or positional relationship based on the orientation or positional relationship shown in the drawings. These terms are only used to facilitate the description of the present disclosure and to simplify the description, and are not intended to indicate or imply that the devices or elements referred to must have a particular orientation, be constructed in a particular orientation, and operate in a particular manner. Therefore, these terms are not to be construed as limiting the present disclosure.

Furthermore, the terms “first” and “second” are used for descriptive purposes only and are not to be construed as indicating or implying relative importance or as implying a quantity of the indicated features. Thus, a feature defined as “first” or “second” may explicitly or implicitly include at least one of the features. In the description of the present disclosure, “a plurality” means at least two, such as two, three, unless specifically defined otherwise.

In the present disclosure, unless otherwise specified and limited, the terms “mounted”, “connected”, “connected”, “fixed” and the like are to be interpreted in a broad sense, for example, they may be fixedly connected, detachably connected, integrally connected, mechanically connected, or electrically connected. It may be directly connected or indirectly connected through an intermediate medium, and it may be the internal communication of two elements or the interaction relationship of two elements, unless otherwise expressly defined. Those skilled in the art can understand the specific meaning of the above terms in the present disclosure according to the specific situation.

In the present disclosure, unless explicitly stated or defined otherwise, a first feature “on” or “under” a second feature may mean that the first and second features are in direct contact, or that the first and second features are in indirect contact through an intermediate medium. Also, a first feature “on”, “above” and “over” a second feature may mean that the first feature is directly above or obliquely above the second feature, or simply mean that the first feature is at a higher level than second feature. A first feature “below”, “under” and “beneath” a second feature may mean that that first feature is directly below or obliquely below the second feature, or simply mean that the first feature is at a lower level than second feature.

It should be noted that when an element is referred to as being “fixed to” or “disposed on” another element, it may be directly on the other element, or an intervening element may also be present. When an element is considered to be “connected” to another element, it may be directly connected to the other element, or there may be an intervening element. The terms such as “vertical”, “horizontal”, “upper”, “lower”, “left”, and “right” are used herein for illustrative purposes only and are not intended to be exclusive embodiments.

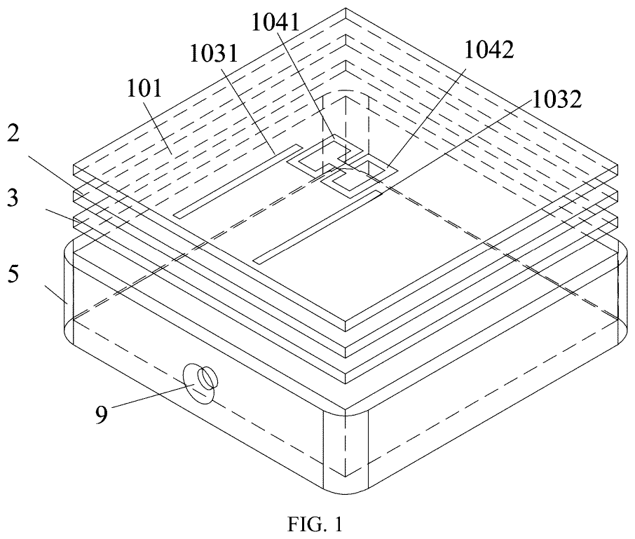

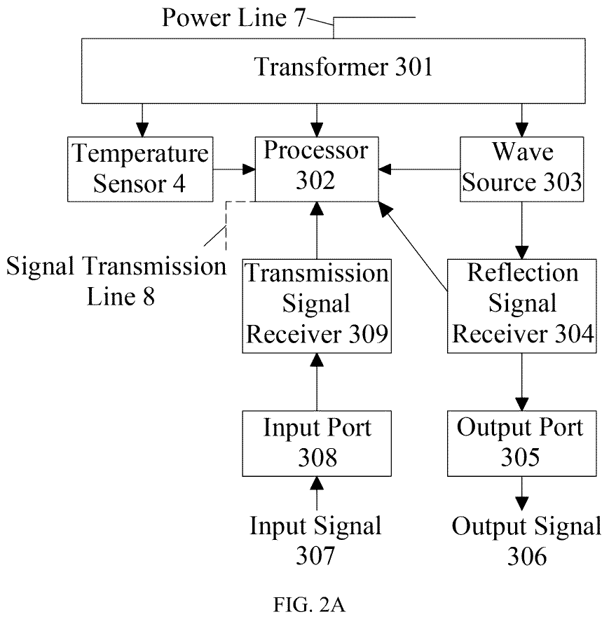

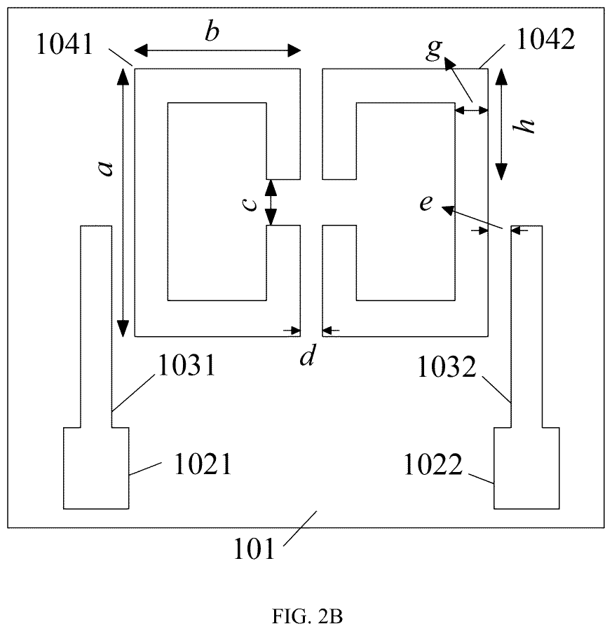

Referring to FIG. 1 and FIGS. 2A and 2B, embodiments of the present disclosure provide a microwave ice detection device, system and method based on a capacitively coupled split-ring resonator. The device includes a microwave resonant sensor 1, a substrate 101, an SubMiniature version A (SMA) connector, a first signal interface 1021, a second signal interface 1022, a copper foil, a first microstrip line 1031, a second microstrip line 1032, a first split ring 1041, a second split ring 1042, a metal shielding plate 2, a microwave signal controller 3, a temperature sensor 4, an ice thickness detector housing 5, a power line 7, a signal transmission line 8 and a power line hole 9.

The microwave resonant sensor 1 is located at the topmost of the whole device, the metal shielding plate 2 and the microwave signal controller 3 are sequentially arranged below the microwave resonant sensor 1. The microwave resonant sensor 1, the metal shielding plate 2 and the microwave signal controller 3 are placed in the ice thickness detector housing 5 after assembled, and the temperature sensor 4 is embedded on the microwave signal controller 3 and tightly attached to the outer wall of the ice thickness detector housing 5 to measure the ambient temperature outside the device. The microwave signal controller 3 may be connected with the microwave resonant sensor 1 via microwave signal transmission line such as a coaxial transmission line or a microstrip line. The power supply of the whole device is introduced via the power line 7 to maintain the work of the device, and the detection result is transmitted to equipment such as a computer via the signal transmission line 8. In the initial state, the microwave resonant sensor 1 has a smooth surface and is exposed to the environment. Once ice formation occurs on its surface, the ice is formed in an ice layer detection area 6 and covers the surface of the microwave resonant sensor 1.

FIGS. 2A and 2B is a structural diagram of a controller and a detection plane of the microwave ice thickness detection device based on the capacitively coupled split-ring resonator. FIG. 2A shows the internal structure of the microwave signal controller 3, which is powered via the power line 7, and the transformer 301 converts 220V alternating current (AC) into 12V direct current (DC) to supply power to the temperature sensor 4, the processor 302 and the wave source 303. When the device works, the wave source 303 emits a microwave signal with constant power or variable frequency, which is transmitted to the output port 305 via the reflection signal receiver 304. The information related to the signal emitted by the wave source 303 and the reflection signal received by the reflection signal receiver 304 are also transmitted to the processor 302 for recording. The input signal introduced by the transmission signal receiver 309 through the input port 308 is transmitted to the processor 302, and the reflection signal and the wave source signal are analyzed to obtain the relevant microwave scattering parameters. FIG. 2A shows the structure of the detection plane, the copper foil is fabricated on the substrate 101 by an etching process, and the SMA connector is soldered to the copper foil. The whole detection plane is connected with the controller 3 via the SMA connector, specifically, the output port 305 and the input port 308 are connected with the second signal interface 1022 and the first signal interface 1021, respectively; the copper foil is etched on the substrate 101 to construct structures of capacitively coupled split rings, and the structure dimensions are marked by a-g in the figure.

In the embodiment, the metal shielding plate 2 may be a metal material with good conductivity, such as a copper plate, a stainless steel plate. The metal shielding plate 2 may be of a sheet structure, a columnar structure, and the like; the controller 3 may be integrally manufactured by a printed circuit board technology, and may also be assembled and manufactured by constructing various structures. The controller 3 may be arranged in the ice thickness detector housing 5, and may also be independent of the whole detection equipment and exist as an independent module. The temperature sensor 4 may be a resistance thermometer, a thermocouple and other temperature measurement sensors, and particularly, the thermocouple temperature sensor with small volume may be selected, which can significantly reduce the volume of the whole device. The ice thickness detector housing 5 may be made of metal such as aluminum alloy, stainless steel, or non-metal materials such as ceramics, plastics, so as to protect the microwave signal controller 3 from being damaged by external influence. The power line 7 may be connected to external circuits for power supply, or simplistically, a device's built-in power supply may be used for power. The signal transmission line 8 may transmit the detection result to a monitor via a wired connection or a wireless connection.

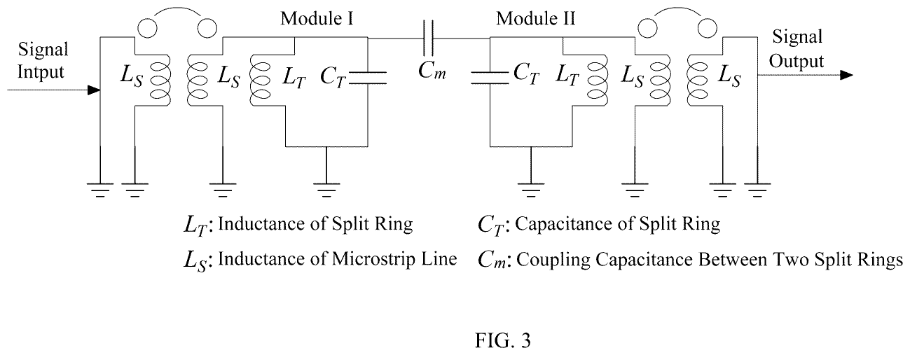

FIG. 3 shows an equivalent circuit diagram of the microwave resonant sensor of the microwave ice thickness detection device based on the capacitively coupled split-ring resonator. Based on the lumped parameter method, the elements in the capacitively coupled split-ring circuit are abstracted into equivalent substrate components such as resistors, capacitors and inductors, so as to realize convenient circuit analysis and calculation. The total inductance L of the equivalent circuit is composed of the inductance Lₛ of the microstrip lines and the inductance Lᵣ of the split rings, wherein the inductance of the split rings is dominant, so the total inductance L of the equivalent circuit may be approximately calculated by the following formula. The total capacitance C of the equivalent circuit is composed of the capacitance Cᵣ of the split rings in the equivalent circuit and the coupling capacitance Cₘ between the split rings, and is calculated by the following formula.

$$\begin{matrix}L \approx \frac{{μ}_{0} ( 4 a - c )}{2 π} [ ln ( \frac{4 a - c}{2 b} ) + \frac{1}{2} ] , \\ {C}_{r} \approx \frac{{ε}_{0} {ε}_{r} a b}{c} , \\ {C}_{m} = \frac{{ε}_{0} {ε}_{r} f ( 2 a - c )}{2 d} ,\end{matrix}$$

where, μ₀ is the vacuum permeability, μ₀=4π×10⁻⁷N/A²; a, b, c and d are the structure size parameters in FIG. 2B; ε=ε₀εᵣ is the true permittivity of the medium, ε₀ and εᵣ are the vacuum permittivity and the relative permittivity, respectively, the vacuum permittivity ε₀=8.85×10⁻¹² F/m.

Upon detecting frost, ice and water, if the effective detection range of the microwave resonant sensor is not completely filled with the substance to be detected, the detection object of the microwave resonant sensor is the mixture of the substance to be detected and air, and the permittivity of the mixture may be calculated by the permittivity index model, that is, the following equation. This equation gives the complex permittivity εₘᵢₓ of the mixture as a function of the complex permittivity εᵢ of its constituents and the relative volume fraction fᵢ:

$${ε}_{m i x}^{n} = \sum {f}_{i} \cdot {ε}_{i}^{n} ( \sum {f}_{i} = 1 ) ,$$

where, fᵢ is the volume fraction of the ith component, Σfᵢ=1; the index n is the empirical parameter of the model, and 0<n<1, when calculating the permittivity of the two-phase mixture, n=⅓.

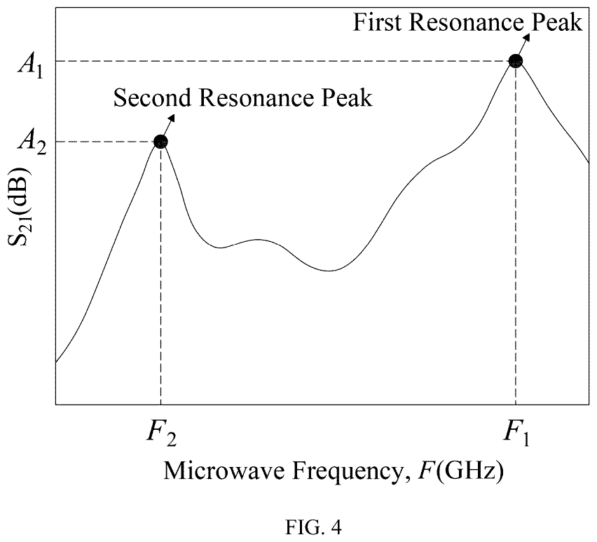

The impedance of the equivalent circuit of the microwave resonant sensor is related to the frequency of the electrical signal. When the impedance in the circuit is minimum, the transmission loss of the electrical signal in the circuit is minimized. The circuit state at this time is called circuit resonance, and the frequency of the electrical signal in the resonance state is the resonance frequency. FIG. 4 is a schematic diagram showing the change of the parameter S₂₁ of the microwave resonant sensor based on the capacitively coupled split rings with the microwave frequency under no-load conditions, in which two resonance peaks exist. Values of the parameter S₂₁ and frequencies in the resonance peak states are a first resonance frequency F₁, a first resonance amplitude A₁, a second resonance frequency F₂, and a second resonance amplitude A₂; the first and second resonance frequencies of the capacitively coupled split rings in the resonance states may be calculated by the following equations, respectively:

$$\begin{matrix}{F}_{1} = \frac{1}{2 π \sqrt{L ( {C}_{r} + {C}_{m} )}} , \\ {F}_{2} = \frac{1}{2 π \sqrt{L ( {C}_{r} - {C}_{m} )}} .\end{matrix}$$

When passing through some substances, reflection, microwaves may undergo transmission and absorption. The microwave absorption power of the medium is expressed by the following equation, which indicates that the microwave absorption power is proportional to the relative permittivity εᵣ of the medium. The relative permittivity of air is approximately 1, the relative permittivity of ice is approximately 3.2, and the relative permittivity of water is approximately 80, so the absorption power of ice and water to microwave is greater than that of air, and the transmission loss of microwave signal may increase when water accumulates or ice forms on the surface of the microwave resonant sensor, the equation is as follows:

$$P = 2 π {FE}^{2} {ε}_{r} t g δ ,$$

where, F is a microwave frequency; E is an electric field intensity of the microwave signal; tgδ is the tangent of the dielectric loss angle of the substance to be measured. Substituting the equation of the first resonance frequency F₁ into the above equation, the microwave absorption power at the first resonance frequency is obtained as shown in the following equation. The analysis of the microwave absorption power at the second resonance frequency is similar to that at the first resonance frequency. The increase of the capacitance value may lead to the decrease of the absorption power at the resonance frequency, and the increase of the relative permittivity of the substance to be measured may lead to the increase of the absorption power. Because the capacitance value is proportional to the relative permittivity, the increase of the relative permittivity of the substance to be measured may lead to the increase of the loss during the microwave transmission at the resonance frequency. The microwave absorption power at the first resonance frequency is:

$${P}_{1} ∝ \frac{1}{\sqrt{L ( {C}_{r} + {C}_{m} )}} {E}^{2} {ε}_{r} t g δ .$$

The definition of the microwave scattering parameter S₂₁ of the microwave resonant sensor is shown in the following formula. The larger the parameter S₂₁ is, the smaller the loss of signal transmission is. Combined with the analysis of the above equation, it may be seen that at the resonance frequency, the loss during the microwave transmission increases with the increase of the permittivity, so the parameter S₂₁ may decrease with the increase of the permittivity. The microwave scattering parameter S₂₁ is defined as:

$${S}_{21} = - 20 log ( \frac{{V}_{2}}{{V}_{1}} ) = - 10 log ( \frac{{P}_{2}}{{P}_{1}} ) ,$$

where, P₂ denotes a microwave absorption power at the second resonance frequency.

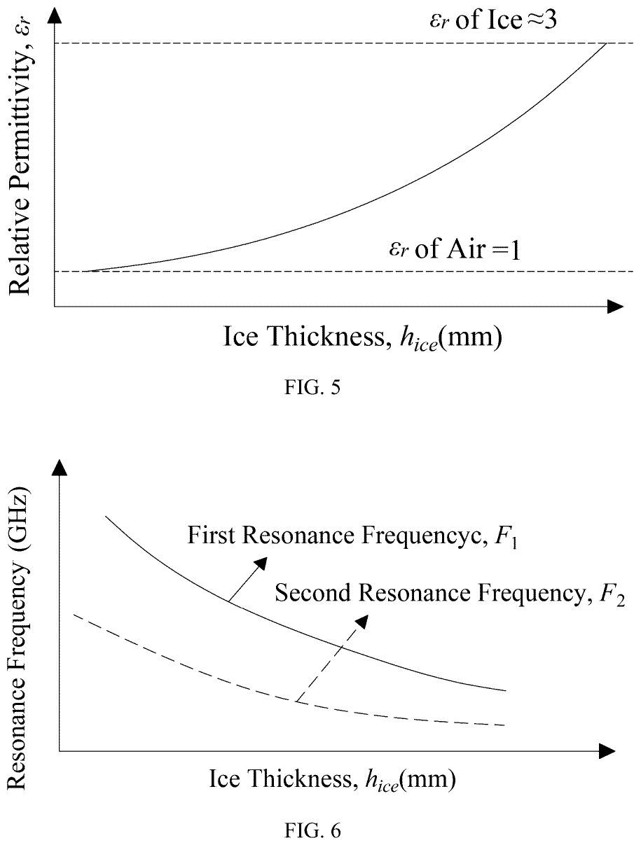

When ice formation does not occur on the measurement surface, the microwave resonant sensor is exposed to the ambient air, and the microwave resonant sensor detects the air within a certain range of the measurement surface. When ice formation occurs on the measurement surface, both ice and air exist on the measurement surface, and the ice-air mixture is detected. As a result, the relative permittivity of the substance to be detected, which is the most important physical characteristic affecting the detection result of the device, changes. FIG. 5 shows a schematic diagram of the change of the relative permittivity with the ice thickness. The relative permittivity of air is approximately 1, and that of ice is approximately 3. Therefore, according to the calculation equation of the relative permittivity of the mixture, the relative permittivity of the mixture falls within the range from 1 (the relative permittivity of pure air) to 3 (the relative permittivity of ice). As the ice thickness gradually increases, the volume fraction of ice in the mixture increases, and the relative permittivity of the mixture also gradually increases.

It can be inferred from the above equation, as ice thickness (volume fraction of ice) increases, the relative permittivity of the ice-air mixture as the substance to be measured increases gradually, which may lead to the increase of the capacitance value in the equivalent circuit of the ice thickness detector, thus reducing the resonance frequency. FIG. 6 shows a schematic diagram of the change of the resonance frequency with the volume fraction of ice (ice thickness). When the ice thickness gradually increases, the resonance frequencies F₁ and F₂ corresponding to the two obvious resonance peaks of the microwave resonant sensor gradually decrease, and the decrease rate of the resonance frequency gradually decreases with the increase of the thickness. At the same time, the difference ΔF (F₁−F₂) between the two resonant frequencies also decreases gradually with the increase of the thickness, so the two resonant frequencies and the difference of the microwave resonant sensor decrease monotonically with the increase of the ice thickness, and the microwave resonant sensor has a good ability to reflect the ice thickness, which proves the reliability of the method for detecting the ice thickness.

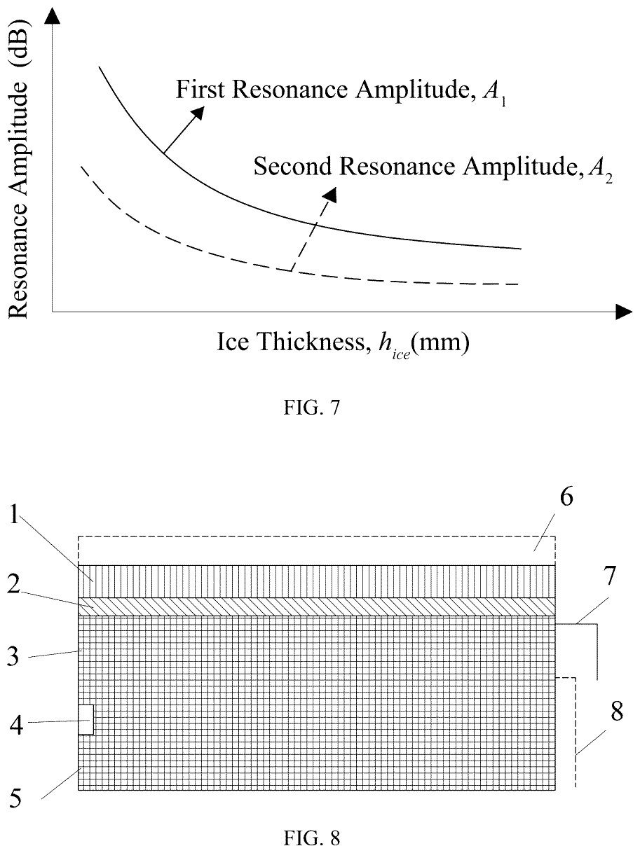

The loss tangent of air is 0, and the loss tangent of pure ice at −10° C. is approximately 20. According to the equation of the second resonance frequency F₂, the microwave absorption power of the substance to be measured is proportional to the relative permittivity and loss tangent of the substance. Therefore, with the increase of the relative volume fraction of ice in the ice-air mixture, the microwave absorption power of the mixture increases, which leads to the decrease of the energy transmitted to the input port 308 through the substance to be measured, and leads to reduce of the parameter S₂₁ according to the equation of the microwave absorption power of the medium, and also the reduce of the resonance amplitude. FIG. 7 shows the variation of the resonance amplitude with the decrease of the volume fraction of ice.

Specifically, as shown in FIG. 8, the microwave resonant sensor 1, the metal shielding plate 2 and the microwave signal controller 3 are arranged in sequence from top to bottom, and are placed in an ice thickness detector housing 5 for protection, and a power line hole 9 for a power line 7 is reserved on the ice thickness detector housing 5 for introducing power supply.

The built-in microwave signal controller is replaced by a vector network analyzer (VNA) and a computer 3. The influence of different thickness of ice slices placed on the sensor surface on the microwave transmission parameters is analyzed and tested. The copper foil is etched on the substrate 101 to construct a capacitively coupled split-ring structure, and the structural dimensions of the copper foil are a=10.5 mm, b=6.5 mm, c=1.7 mm, d=1.0 mm, e=0.8 mm, g=1.4 mm, and h=4.4 mm. The substrate is a rectangle with a size of 60 mm and a thickness of 1.2 mm. The specific steps of ice thickness detection are as follows:

Step 1, the input and output interfaces of the VNA vector network analyzer are respectively connected with a first signal interface 1021 and a second signal interface 1022 on a measurement plane via microwave transmission lines. The first signal interface 1021 and the second signal interface 1022 are SMA connectors for connection. The analyzer is connected with a PC via a signal line, and the PC is used for recording and analyzing the microwave scattering parameters under different frequencies and ice thicknesses in real time.

Step 2, the temperature of the detection surface is controlled to be lower than freezing point temperature by arranging a low-temperature heat exchanger below the microwave resonant sensor, so as to avoid the deviation of the test result caused by the melting of ice during the test.

Step 3, the prepared ice slices with different thicknesses are placed above the measurement plane of the microwave resonant sensor, and the real-time data recorded by the VNA vector analyzer within 2 minutes after placing the ice slices are recorded at a time interval of 5 seconds, and the recorded data results are displayed on the PC every 5 seconds.

Step 4, the peak value of a curve of the parameter S₂₁ varying with the frequency recorded by the VNA vector analyzer is extracted, and the change of the resonance frequencies and resonance amplitudes of the first resonance peak and the second resonance peak along with the ice thickness are analyzed.

And Step 5, a double-peak ice thickness detection relational expression is fitted according to the analysis result, thus simplifying an icing detection process, namely obtaining ice thickness information according to a microwave detection result obtained by real-time detection.

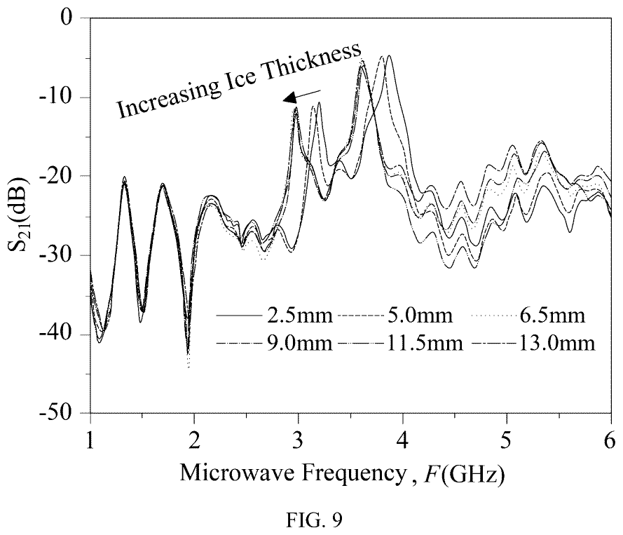

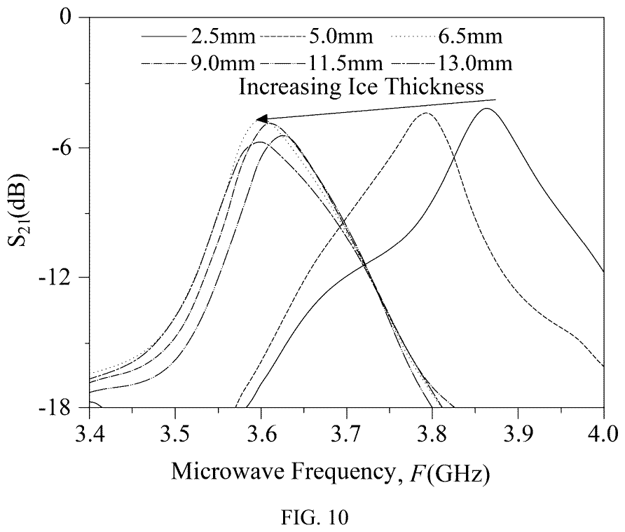

FIGS. 9 and 10 show the change of the recorded parameter S₂₁ with the frequency for different ice thicknesses tested by the ice detection sensor. Two distinct peaks appear at microwave frequencies of approximately 3 GHz and 3.7 GHz. The change of the maximum peak in the range of 3.2 GHz to 4.0 GHz is shown in FIG. 10. It can be seen that as the ice thickness increases from 2.15 mm to 12.00 mm, the maximum resonance peak shifts toward the direction of decreasing frequency and decreasing amplitude. In addition, the second peak at 3 GHz also shows the same change trend. This phenomenon shows that the resonance frequency and amplitude of the two resonance peaks have a monotonic change trend with the ice thickness, which enables establishing a mathematical relationship related to ice thickness and thus achieves simple, fast, and accurate ice thickness detection.

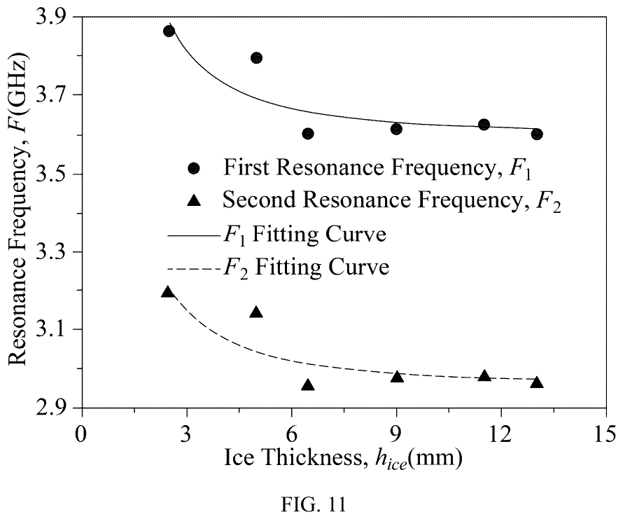

FIG. 11 is a graph of the change of the resonance frequency with the ice thickness. The resonant frequencies of the two peak points under different ice thicknesses are extracted, and the changes of the resonant frequencies with the ice thickness are drawn. It may be seen that with the gradual increase of the ice thickness from 2.15 mm to 12.00 mm, the first resonance frequency and the second resonance frequency show a gradual decreasing trend. Polynomial fitting is carried out based on the experimental detection results. A mathematical relationship between the first resonance frequency and the ice thickness and a mathematical relationship between the second resonance frequency and the ice thickness are respectively established as follows:

$$\begin{matrix}{F}_{1} = 1.1 \; 59 \times {h}_{ice}^{- 1.5} + 3.255 \\ {F}_{2} = 1.03 \times {h}_{ice}^{- 1.5} + 2.952\end{matrix} ,$$

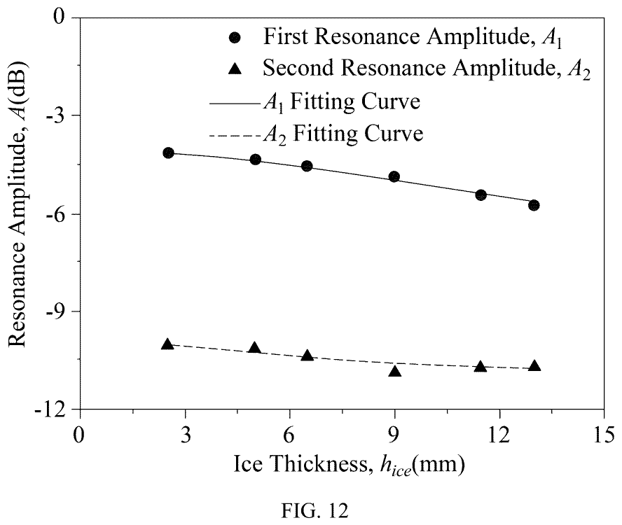

As shown in FIG. 12, the resonance amplitudes of two peak points under different ice thicknesses are extracted for the graph of resonance amplitude varying with ice thickness, and the change of resonance amplitude with ice thickness is drawn. It can be seen that with the gradual increase of the ice thickness from 2.15 mm to 12.00 mm, the first resonance amplitude shows a gradually decreasing trend. The second resonance amplitude is unstable near 0.15 mm, but it also shows a decreasing trend with the increase of ice thickness. Polynomial fitting is performed based on the experimental detection results, and a mathematical relationship between the first resonance amplitude value and the ice thickness and a mathematical relationship between the second resonance amplitude value and the ice thickness are established respectively as follows:

$$\begin{matrix}{A}_{1} = - 4.77 log ( 1 + 0.031 {( {h}_{ice} - 2.5 )}^{- 1.5} ) - 4.12 \\ {A}_{2} = - 0.6 log ( 1 + 0.417 {( {h}_{ice} - 2.5 )}^{- 1.5} ) - 10 \text{.027} .\end{matrix} ,$$

An accurate and stable ice thickness detection result is obtained by taking the ice thickness calculated by the first peak resonance amplitude value A₁ as the main value, taking the ice thickness results calculated by the first resonance frequency F₁, the second resonance amplitude value A₂ and the second resonance frequency F₂ as the reference, and averaging the four calculation results.

Compared with an optical method, a mechanical method and other ice detection methods, the method of the present disclosure has the advantages of simple principle and operation, high measurement stability and the like, and has great application potential.

The detection surface coupling mechanism of the present disclosure is diversified in form, two split ring structures may be coupled in a capacitance form, multiple split rings may be coupled in an array form, to obtain more resonance peak values, increase the ice thickness detection parameters of the device, and improve the accuracy and the stability of ice thickness detection.

According to the method of the present disclosure, the first peak resonance amplitude value is used as a main parameter of ice thickness detection, the first resonance frequency, the second resonance frequency and the second resonance amplitude value are used as auxiliary parameters, and an ice thickness detection result is calculated through the four parameters, so that the stability and the accuracy of ice thickness detection are greatly improved.

According to the method of the present disclosure, the ice thickness detection model is constructed, and the icing detection process is demonstrated in detail through experiments, so that a relational detection expression between the first and second resonance peak parameters and the ice thickness may be obtained, and icing information may be simply and quickly obtained through a mathematical model, thereby avoiding the problem that icing detection time is increased due to a complex ice thickness detection model. The temperature sensor is arranged to measure the ambient temperature so as to control the device to work at the ambient temperature which is easy to freeze, thereby avoiding the energy loss of detection in the absence of ice.

Through the present disclosure, the detection surface, the metal shielding plate and the controller can all be flattened, so that the thickness of the whole sensor can be controlled below centimeter level to realize patch type detection. The capacitively coupled split-ring microwave resonant icing detection device also has the advantages of high cost performance, environmental friendliness, small size, portability and the like, and may be widely applied to various detection fields.

The above embodiments only show several embodiments of the present disclosure, and the description is more specific and detailed, but it shall not be understood as limiting the scope of the disclosure. It should be noted that those of ordinary skill in the art may make various modifications and improvements without departing from the spirit of the present disclosure, which fall within the scope of the present disclosure. Therefore, the scope of protection of the present disclosure shall be subject to the appended claims.

What is claimed is:

1. A microwave ice detection device based on a capacitively coupled split-ring resonator, comprising a microwave signal controller and a microwave resonant sensor in communication connection with the microwave signal controller;
wherein, the microwave resonant sensor comprises a substrate arranged on a top surface of a metal shielding plate, wherein a copper foil is etched on a top surface of the substrate;
wherein, the copper foil comprises a first split ring and a second split ring which are arranged opposite to each other, and openings of the first split ring and the second split ring face with each other; a first microstrip line is provided on a side portion of the first split ring and extends to an edge of the substrate; a second microstrip line is provided on a side portion of the second split ring and extends to the edge of the substrate;
in response to ice formation on a surface of the microwave resonant sensor, the microwave signal controller transmits a microwave signal with a variable frequency to the copper foil, and the first split ring and the second split ring transmit, to a mixture on the surface of the microwave resonant sensor, a microwave signal, which is reflected, transmitted and absorbed by the mixture to form a measurement signal; and
the microwave signal controller is configured to acquire a resonance amplitude value and a resonance frequency of the measurement signal, after the measurement signal is transmitted to the microwave signal controller, and acquire ice thickness information according to the resonance amplitude value and the resonance frequency.

2. The microwave ice detection device based on the capacitively coupled split-ring resonator according to claim 1, wherein an end of the first microstrip line is provided with a first signal interface, and an end of the second microstrip line is provided with a second signal interface; and
the first signal interface is connected to an input port of the microwave signal controller, and the second signal interface is connected to an output port of the microwave signal controller.

3. The microwave ice detection device based on the capacitively coupled split-ring resonator according to claim 1, wherein the microwave resonant sensor, the metal shielding plate and the microwave signal controller are assembled and arranged in an ice thickness detector housing in sequence, and the ice thickness detector housing is installed on a surface of icing equipment.

4. The microwave ice detection device based on the capacitively coupled split-ring resonator according to claim 3, wherein a plurality of power line holes are formed in a side wall of the ice thickness detector housing; and
a power line is arranged in one of the plurality of power line holes, and is connected with a transformer of the microwave signal controller; and
a signal transmission line is arranged in another one of the plurality of power line holes, and is connected with a processor of the microwave signal controller.

5. The microwave ice detection device based on the capacitively coupled split-ring resonator according to claim 1, wherein for the microwave signal controller, components are embedded on a printed circuit board, and the printed circuit board formed is installed in an ice thickness detector housing or independently arranged outside the microwave ice detection device.

6. A microwave ice detection system based on a capacitively coupled split-ring resonator, comprising a microwave ice detection device based on the capacitively coupled split-ring resonator, and further comprising:
a temperature sensor, embedded on the microwave signal controller, having one end connected to a transformer of the microwave signal controller and an other end connected to a processor of the microwave signal controller, and configured to measure an external ambient temperature;
a wave source, embedded in the microwave signal controller, connected to the transformer and the processor of the microwave signal controller, and configured to emit a microwave signal with constant or varying power;
a transmission signal receiver, embedded in the microwave signal controller, having one end connected to the processor of the microwave signal controller and an other end connected to an input port of the microwave signal controller, and configured to introduce the measurement signal from the microwave resonant sensor; and
a reflection signal receiver, embedded in the microwave signal controller, having one end connected to the processor of the microwave signal controller and an other end connected to the output port of the microwave signal controller, and configured to receive the microwave signal emitted by the wave source and input the microwave signal into the microwave resonant sensor via the output port;
wherein, the microwave ice detection device based on the capacitively coupled split-ring resonator comprises: a microwave signal controller and a microwave resonant sensor in communication connection with the microwave signal controller;
wherein, the microwave resonant sensor comprises a substrate arranged on a top surface of a metal shielding plate, wherein a copper foil is etched on a top surface of the substrate;
wherein, the copper foil comprises a first split ring and a second split ring are arranged opposite to each other, and openings of the first split ring and the second split ring face with each other; a first microstrip line is provided on a side portion of the first split ring and extends to an edge of the substrate; a second microstrip line is provided on a side portion of the second split ring and extends to the edge of the substrate;
in response to ice formation on a surface of the microwave resonant sensor, the microwave signal controller transmits a microwave signal with a variable frequency to the copper foil, and the first split ring and the second split ring transmit, to a mixture on the surface of the microwave resonant sensor, a microwave signal, which is reflected, transmitted and absorbed by the mixture to form a measurement signal; and
the microwave signal controller is configured to acquire a resonance amplitude value and a resonance frequency of the measurement signal, after the measurement signal is transmitted to the microwave signal controller, and acquire ice thickness information according to the resonance amplitude value and the resonance frequency.

7. The microwave ice detection system based on the capacitively coupled split-ring resonator according to claim 6, wherein the transformer is configured to convert 220V alternating current into 12V direct current, the 12V direct current drive the wave source to emit the microwave signal with constant or variable power, and the microwave signal is transmitted to the output port via the reflection signal receiver and transmitted to the microwave resonant sensor via the second signal interface to detect the ice thickness information; and
a detection signal is transmitted to the input port via the first signal interface, transmitted to the processor via the transmission signal receiver, to be comprehensively analyzed with the reflection signal in the reflection signal receiver and the wave source signal, thereby obtaining a microwave scattering parameter, and the ice thickness information is obtained through the microwave scattering parameter.

8. The microwave ice detection system based on the capacitively coupled split-ring resonator according to claim 6, wherein an end of the first microstrip line is provided with a first signal interface, and an end of the second microstrip line is provided with a second signal interface; and
the first signal interface is connected to an input port of the microwave signal controller, and the second signal interface is connected to an output port of the microwave signal controller.

9. The microwave ice detection system based on the capacitively coupled split-ring resonator according to claim 6, wherein the microwave resonant sensor, the metal shielding plate and the microwave signal controller are assembled and arranged in an ice thickness detector housing in sequence, and the ice thickness detector housing is installed on a surface of icing equipment.

10. The microwave ice detection system based on the capacitively coupled split-ring resonator according to claim 9, wherein a plurality of power line holes are formed in a side wall of the ice thickness detector housing; and
a power line is arranged in one of the plurality of power line holes, and is connected with a transformer of the microwave signal controller; and
a signal transmission line is arranged in another one of the plurality of power line holes, and is connected with a processor of the microwave signal controller.

11. The microwave ice detection system based on the capacitively coupled split-ring resonator according to claim 6, wherein for the microwave signal controller, components are embedded on a printed circuit board, and the printed circuit board formed is installed in an ice thickness detector housing or independently arranged outside the microwave ice detection device.
